(19) United States
(12) Patent Application Publication
(10) Pub. No.: US 2019/0269122 A1
(43) Pub. Date: Sep. 5, 2019

(54) TREE STAND

(71) Applicant: William Delaney Lewis, West Monroe, LA (US)

(72) Inventor: William Delaney Lewis, West Monroe, LA (US)

(21) Appl. No.: 15/911,293

(22) Filed: Mar. 5, 2018

(51) Int. Cl. A01M 31/02

(52) U.S. Cl. CPC A01M 31/02

(57) ABSTRACT

A tree stand (10) is disclosed having a top or seating portion (11) and a bottom or standing portion (12). The top portion includes cable attachment arms (13) mounted to a cantilever frame (16). The cable attachment arms are coupled to a flexible cable (14). The top portion also includes a gimbal or pivot (22) mounted distally the tree engagement portion (19) and a hanging chair or seat assembly (23) coupled to the pivot. The hanging seat assembly includes a quick connect coupler (25), a length of chain, cable, tether, rope, or the like (26) coupled at one end to the coupler, and a chair suspending frame (27) coupled to the opposite end of the chain (28).

### TECHNICAL FIELD

This invention relates to tree stands, and specifically to tree stands adapted to provide different rotatable positions.

### BACKGROUND OF THE INVENTION

Hunters, naturalist and others whom wish to observe animals without disturbing them have utilized devices to hide from view. One common method of hiding oneself is to position yourself above the normal sight line of the animal. As such, for many years tree strands have existed to enable a person to be perched high above the ground. Today, such tree stands are available in three common types or configurations, namely, a lock on type tree stand, a ladder type tree stand and a climbing type tree stand.

The lock on type tree stand typically includes a platform which is mounted to the trunk of a tree. Spikes or the like are driven or attached to the tree to provide access to the platform. These types of tree stands are cumbersome and dangerous to install and use. Another problem with these tree stands is that the platform is designed so that a person faces in only one direction. As such, should an animal appear off to the side or behind the tree, it may be difficult for the person to aim a rifle, bow, camera or other device towards the animal. Furthermore, this may require a person to stand and turn into position for aiming a firearm or bow at an animal, which creates an unsafe scenario which may result in the person falling from the tree stand.

The ladder type tree stand typically includes an elongated ladder having a platform at one end which is leaned against the trunk of a tree. The tree stand includes straps which secure it to the tree. The person scales the ladder and then sits upon the platform. The platform may include a seat, chair or sling to enable to the person to sit comfortably for an extended period of time. Again, a problem with this type of tree stand is that the seat usually faces in only one direction. Again, this may require a person to stand and turn into position for aiming a firearm or bow at an animal, which creates an unsafe scenario which may result in the person falling from the tree stand.

Climbing type tree stands typically include two pieces which move independently from each other. The two pieces are each designed to wrap about the truck of the tree with a set of teeth to dig into the tree when leverage is applied to the piece. The two pieces include an upper piece and a lower piece, wherein each piece is moved up the tree, secured by applying leverage, then the other piece is moved in the same manner so that the tree stand “crawls” up the tree in a succession of incremental moves. Again, a problem with this type of tree stand is that the seat attached to the upper piece typically faces in only one direction. Once again, this may require a person to stand and turn into position for aiming a firearm or bow at an animal, which creates an unsafe scenario which may result in the person falling from the tree stand.

To overcome the problem of a fixed seating position, some tree stands have been designed to include a seat which is coupled to a rotating pedestal to provide rotational movement to the seat. This type of tree stand is shown in U.S. Pat. Nos. 8,556,036 and 8,708,104, as well as U.S. Patent Application Publication No. 2011/0308887. A problem with this type of pedestal seating is that the seat may tend to rotate if the platform to which the pedestal is mounted is not perfectly flat or horizontal. Another problem with this type of seating is that it may provide rotation, but, the line of sight is encumbered by the tree itself.

A tree stand has also been developed which includes a frame having a rotatable outer ring from which depends a seat, as shown in U.S. Pat. No. 5,842,540. A problem with this type of tree stand is that a person utilizing this device stands or sits within the confines of the outer frame or tubular frame. As such, the outer frame surrounds the person and obstructs the free movement of the rifle, bow or camera, as well as the view of the person. Again, a problem with this type of seating is that it may provide rotation, but, the line of sight is encumbered by the tree itself.

Accordingly, it is seen that a need remains for a tree stand which provides the ability to rotate the seat to different position without requiring the tree stand to be perfectly situated in a horizontal position or without interfering with the free movement of the person or devices held by the person. It is to the provision of such therefore that the present invention is primarily directed.

### SUMMARY OF THE INVENTION

A tree stand adapted for use with an upright structure comprises a top portion which may be coupled to the upright structure, a pivot mounted to the top portion, and a hanging chair assembly coupled to the pivot. The hanging chair assembly including a chair suspending frame and a chair coupled to the chair suspending frame. The having chair assembly is configured so that a person sitting upon the chair is positioned entirely below the top portion.

### BRIEF DESCRIPTION OF THE DRAWING

FIG. 1 is a perspective view of a climbing type tree stand embodying principles of the invention in a preferred form.

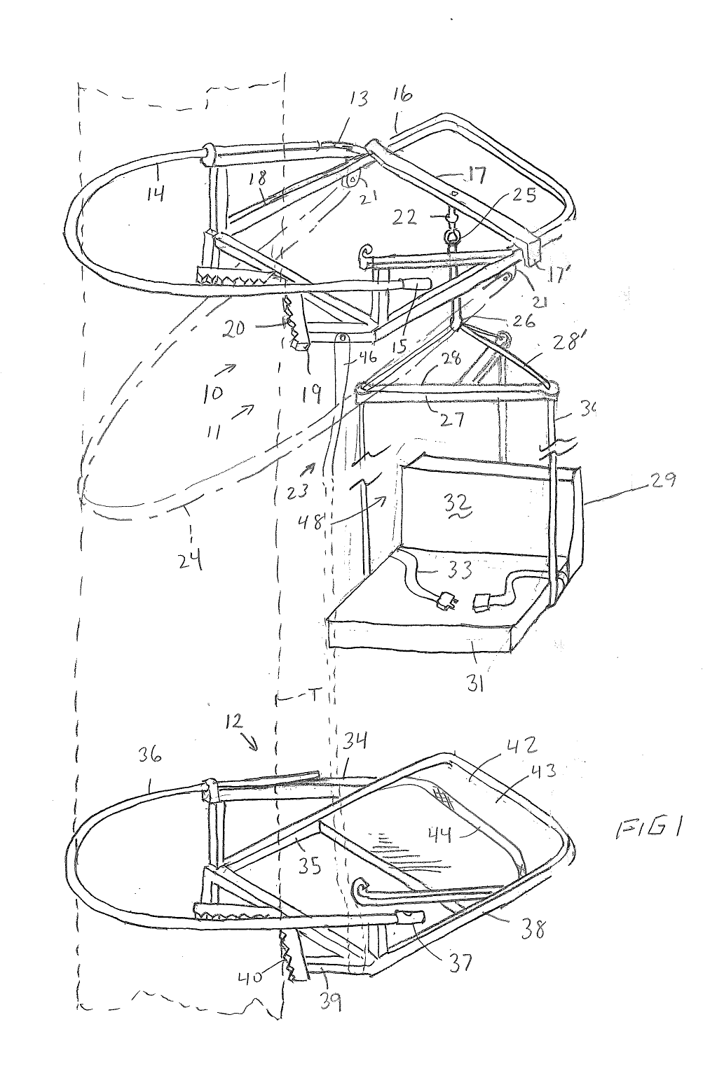

FIG. 2 is a perspective view of a ladder type tree stand embodying principles of the invention in another preferred form.

### DETAILED DESCRIPTION

With reference next to the drawings, there is shown a climbing type tree stand 10 embodying principles of the invention in a preferred form. The tree stand 10 is configured to be used in conjunction with an upright structure such as the trunk of a tree, pole or other similar structure T.

The tree stand 10 includes a top or seating portion 11 and a bottom or standing portion 12. The top portion 11 includes a pair of cable attachment arms 13 mounted to a cantilever frame 16. The cable attachment arms 13 are coupled to a flexible cable 14 wherein one end of the cable is permanently coupled to one cable arm 13 and the opposite, free end 15 of the cable 14 is releasably coupled to the other cable arm 13. The cantilever frame 16 includes a generally rectangular body portion 18 and a tree engagement or biting portion 19 which includes a plurality of teeth 20 configured to bite or dig into the tree when downward pressure is applied to the cantilever frame 16. As used entirely herein, the term cable is intended to include all materials conventionally know to be used with such tree stands, including cables, straps, chains, bent bars, and the like.

The tree stand 10 includes a pair of stabilizer brackets or eyes 21 positioned below the cantilever frame 16 and a ratchet style strap 24 removably coupled to the stabilizer eyes 21. The strap 24 provides an additional force upon the tree engagement portion 19 to cause the teeth 20 to dig into the tree. The configuration of the cable 14, cantilever frame 16 and strap 24 creates an engineered triangle for stability. The positioning of the eyes 61 below the cantilever frame insures a downward force being applied to the cantilever frame when the strap 24 tightened.

The top portion 11 also includes a removable support bar or bracket 17 which includes a gimbal or pivot 22 which is mounted distally the tree engagement portion 19. The support bracket 17 has down turned ends 17′ which restrict movement of the support bracket 17 relative to the cantilever frame 16 once it is coupled. A hanging chair or seat assembly 23 is coupled to the pivot 22. The hanging seat assembly 23 includes a quick connect clip or coupler 25, a length of chain, cable, tether, rope, or the like 26 coupled at one end to the coupler 25, and a chair suspending frame 27 coupled to the opposite end of the chain 28. The chair suspending frame 27 may be in the form of horizontal metal bars 28 and two or more suspension cables 28′.

A chair, seat or sling 29, collectively referenced herein as a chair, is suspended from the chair suspending frame 27 through adjustable straps 30. The chair 29 includes a seating portion 31 and a backrest portion 32. A safety belt 33 extends across the chair 29 to secure a person to the chair 29 during use.

Similarly, the bottom portion 12 includes a pair of cable attachment arms 34 mounted to a cantilever frame 35. The cable attachment arms 34 are coupled to a flexible cable 36 wherein one end of the cable 36 is permanently coupled to one cable arm 34 and the opposite, free end 37 of the cable 34 is releasably coupled to the other cable arm 34. The cantilever frame 35 includes a generally rectangular body portion 38 and a tree engagement or biting portion 39 which includes a plurality of teeth 40 configured to bite or dig into the tree when downward pressure is applied to the cantilever frame 35. A platform 42 is coupled to the body portion 38.

The platform 42 includes a top surface 43 and a flexible foot strap 44 extending across the top surface 43. A safety strap 46 is coupled to and extends between the top portion 11 and the bottom portion 12.

In use, the top portion 11 is coupled to a tree by wrapping the flexible cable 14 about the trunk of the tree and coupling the cable's free end 15 to the corresponding cable attachment arm 13. The top portion 11 is then raised along the trunk and downward pressure is applied to the cantilever frame 16 so as to cause the teeth 20 of the tree engagement portion 19 to dig into the trunk and maintain the vertical position of the top portion 11 upon the tree. The hanging chair 23 may be placed within a storage bag that is attached to the top portion 11 during ascent.

Similarly, the bottom portion 12 is coupled to a tree by wrapping the flexible cable 36 about the trunk of the tree and coupling the cable's free end 37 to the corresponding cable attachment arm 34. The bottom portion 12 is then raised slightly along the trunk and downward pressure is applied to the cantilever frame 35 so as to cause the teeth 40 of the tree engagement portion 39 to dig into the trunk and maintain the vertical position of the bottom portion 12 upon the tree. The safety strap 46 is then coupled to both the top portion 11 and bottom portion 12 to prevent their unwanted over separation or accidentally dropping of the bottom portion 12 during ascent or descent.

The person then ascends the tree in conventional fashion by sequentially raising the top and bottom portions independently from each other so as to climb the tree. Once the final position of the top portion is selected, pressure is applied to the cantilever frame 16 to cause the teeth 20 to dig into the tree. The strap 24 is then wrapped about the tree in a position lower than the tree engagement portion 19 and coupled to the stabilizer eyes 21. The strap is then tightened through its ratchet causing the teeth 20 to further dig into the tree and lock the position of the upper portion. The downward force applied by tightening strap 24 causes the cantilever frame to pivot about teeth 20, which in turn, causes additional pressure to be applied to cable 14. This additional pressure on the cable 14 creates a tighter and more stable connection between the tree stand and the tree.

The support bar 17 is then coupled to the cantilever frame. The hanging chair 23 is then removed from the storage bag and coupled to the pivot 22 through the coupler 25. The person may then sit upon the downwardly depending chair 29. The pivot 22 allows for 360 degree rotation of the hanging chair assembly 23, and specifically the chair 29, relative to the top portion 11. The person may place his or her foot upon the bottom portion 12 to gain leverage in pivoting the chair 26.

It should be noted that a person sitting within the hanging chair 23 has an unencumbered view and ability to position a rifle, bow or camera without interference from framework associated with the tree stand 10. The unencumbered view is provided by positioning and configuring the tree stand 10 so that the hanging seat assembly has a size and shape to be positioned below the cantilever frame 16, so that a person sits entirely below the cantilever frame 16. As such, the hanging chair assembly 23 defines a person occupying space 48 which is positioned entirely below the cantilever frame 26. This also allows a person to swing the hanging chair to a position around the tree, if necessary for aiming purposes. This is very different from the prior art device shown in U.S. Pat. No. 5,842,540 wherein the person sits within the confines of the tree stand wherein the circular, tubular frame may interfere with the positioning or line of sight of a rifle, bow, camera or other device utilized by the person.

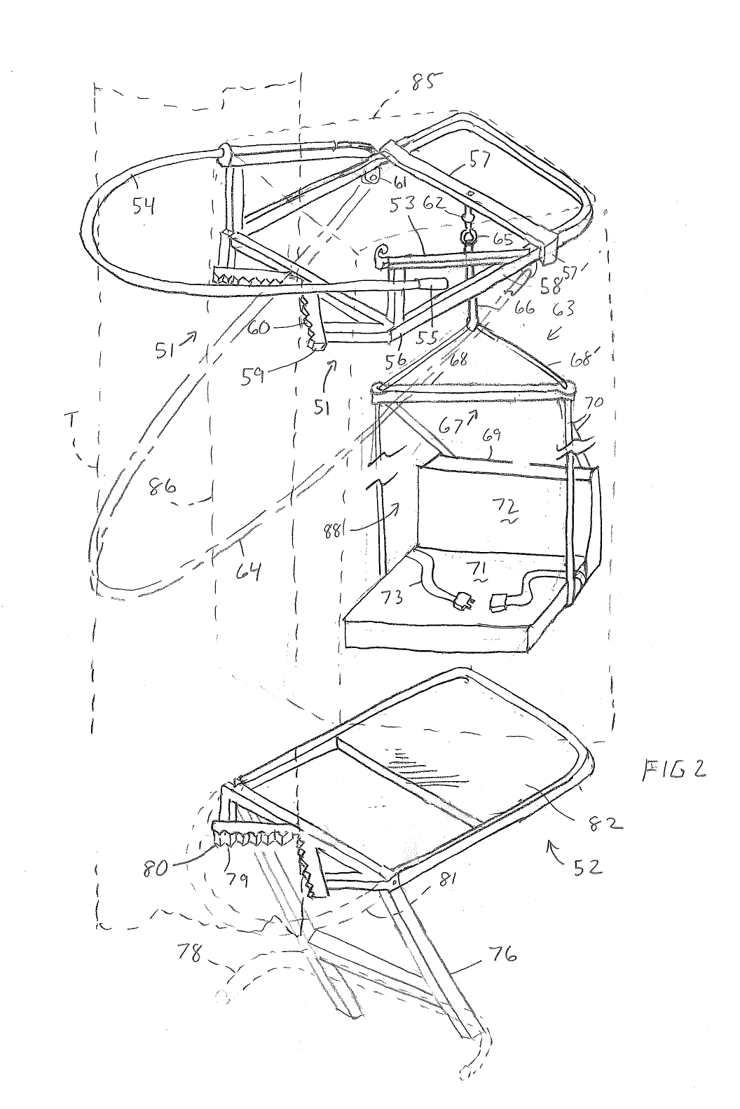

With reference next to FIG. 2 of the drawings, there is shown a ladder type tree stand 50 embodying principles of the invention in another preferred form. The tree stand 50 is configured to be used in conjunction with the trunk of a tree, pole or other similar structure.

The tree stand 50 includes a top or seating portion 51 and a bottom or standing portion 52. The top portion 51 includes a pair of cable attachment arms 53 mounted to a cantilever frame 56. The cable attachment arms 53 are coupled to a flexible cable 54 wherein one end of the cable is permanently coupled to one cable arm 53 and the opposite, free end 55 of the cable 54 is releasably coupled to the other cable arm 53. The cantilever frame 56 includes a generally rectangular body portion 58 and a tree engagement or biting portion 59 which includes a plurality of teeth 60 configured to bite or dig into the tree when downward pressure is applied to the cantilever frame 56.

The tree stand 50 includes a pair of stabilizer brackets or eyes 61 positioned below the cantilever frame 56 and a ratchet style strap 64 removably coupled to the stabilizer eyes 61. The strap 64 provides an additional force upon the tree engagement portion 59 to cause the teeth 60 to dig into the tree. The configuration of the cable 54, cantilever frame 56 and strap 64 creates an engineered triangle for stability. The positioning of the eyes 61 below the cantilever frame insures a downward force being applied to the cantilever frame when the strap 64 is tightened.

The top portion 51 also includes a removable support bar or bracket 57 which includes a gimbal or pivot 62 which is mounted distally the tree engagement portion 59. The support bracket 57 has down turned ends 57′ which restrict movement of the support bracket 57 relative to the cantilever frame 56 once it is coupled. A hanging chair or seat assembly 63 is coupled to the pivot 62. The hanging seat assembly 63 includes a quick connect clip or coupler 65, a length of chain, cable, tether, rope, or the like 66 coupled at one end to the coupler 65, and a chair suspending frame 67 coupled to the opposite end of the chain 68. The chair suspending frame 67 may be in the form of horizontal metal bars 68 and two or more suspension cables 68′.

A chair, seat or sling 69 is suspended from the chair suspending frame 67 through adjustable straps 70 (shown as four straps 70 in FIG. 2). The chair 69 includes a seating portion 71 and a backrest portion 72. A safety belt 73 extends across the chair 69 to secure a person to the chair 69 during use.

The bottom portion 52 includes an elongated ladder portion 76. One of more stabilizing brackets 78 are coupled to the ladder portion 76. The stabilizing brackets 78 may pivot downwardly into engagement with the trunk of the tree. The bottom portion 52 may also include a tree engagement or biting portion 79 which includes a plurality of teeth 80 configured to bite or dig into the tree. The bottom portion 52 may also include straps 81 to secure the ladder portion 76 to the tree. The bottom portion 52 also includes a standing platform 82.

The tree stand, as with the previous embodiment, may include a flexible canopy 85 coupled to the top portion 51 to form a roof to shed the elements from a person utilizing the tree stand 50. Also, the tree stand 50 may include a surrounding enclosure 86 to hide the person and provide additional protection from the elements.

In use, the bottom portion 52 is leaned up against the trunk of a tree so that the stabilizing brackets 78 engage the trunk. The safety straps 81 are then secured about the trunk and coupled to the ladder portion.

A person may then climb the ladder and stand upon standing platform 82. The top portion 51 may be either carried up the ladder by the person or secured to a rope and hoisted up to the person. The top portion 51 is then coupled to a tree by wrapping the flexible cable 54 about the trunk of the tree and coupling the cable's free end 55 to the corresponding cable attachment arm 53. The top portion 51 is then raised along the trunk and downward pressure is applied to the cantilever frame 56 so as to cause the teeth 80 of the tree engagement portion 59 to dig into the trunk and maintain the vertical position of the top portion 51 upon the tree.

Pressure is applied to the cantilever frame 56 to cause the teeth 60 to dig into the tree. The strap 64 is then wrapped about the tree in a position lower than the tree engagement portion 59 and coupled to the stabilizer eyes 61. The strap is then tightened through its ratchet causing the teeth 60 to further dig into the tree and lock the position of the upper portion. The downward force applied by tightening strap 64 causes the cantilever frame to pivot about teeth 60, which in turn, causes additional pressure to be applied to cable 54. This additional pressure on the cable 54 creates a tighter and more stable connection between the tree stand and the tree.

The support bar 57 is then coupled to the cantilever frame. The hanging chair 63 is then removed from the storage bag and connected through the coupler 65 to the pivot 62. The person may then sit upon the downwardly depending chair 69. The pivot 62 allows for 360 degree rotation of the hanging chair assembly 63, and specifically the chair 69, relative to the top portion 51. The person may place his or her foot upon the standing platform 82 to gain leverage in pivoting the chair 66. This also allows a person to swing the hanging chair to a position around the tree, if necessary for aiming purposes.

It should be noted that a person sitting within the hanging chair assembly 63 is again situated entirely below the cantilever frame so as to have an unencumbered view and ability to position a rifle, bow or camera without interference from framework associated with the tree stand 50. As such, the hanging chair assembly 63 defines a person occupying space 88 which is positioned entirely below the cantilever frame 56. The term hanging chair assembly or hanging chair denotes a chair which is hung or suspended from a support, and is not intended to denote a chair or seat which includes a pedestal or other type of support positioned to support the chair from a support located below the height of the chair.

It should be understood that as an alternative to a mechanical pivot, the pivot may be formed by simply incorporating a flexible or twistable link or portion to the hanging chair assembly. For example, a length of flexible strap, cord or chain may couple the having chair assembly to the cantilever frame 16, thereby providing a pivot therebetween by virtue of the strap being capable of bing twisted.

It thus is seen that a tree stand is now provided which overcomes problems associated with tree stands of the prior art. While this invention has been described in detail with particular references to the preferred embodiments thereof, it should be understood that many modifications, additions and deletions, in addition to those expressly recited, may be made thereto without departure from the spirit and scope of the invention.

1. A tree stand adapted for use with an upright structure, the tree stand comprising,
a top portion which may be coupled to the upright structure;
a pivot mounted to said top portion, and
a hanging chair assembly coupled to said pivot, said hanging chair assembly including a chair suspending frame and a chair coupled to said chair suspending frame, the hanging chair assembly being configured so that a person sitting upon said chair is positioned entirely below said top portion.

2. The tree stand of claim 1 wherein said chair includes a plurality of hanging straps extending between said chair and said chair suspending frame, said hanging straps being adjustable in length.

3. The tree stand of claim 1 wherein said hanging chair assembly includes a coupler releasably coupled to said pivot.

4. The tree stand of claim 1 wherein said top portion includes a cantilever frame, a tree engaging portion, and a flexible cable releasably coupled to said cantilever frame.

5. The tree stand of claim 1 further comprising a bottom portion which may be coupled to the upright structure.

6. The tree stand of claim 1 further comprising a canopy coupled to said top portion to form a roof.

7. The tree stand of claim 1 further comprising an enclosure surrounding said hanging chair assembly.

8. A tree stand adapted for use with an upright structure, the tree stand comprising,
a bottom portion which may be coupled to the upright structure, said bottom portion having a standing platform;
a top portion which may be coupled to the upright structure, said top portion having a frame coupled to the upright structure and a hanging chair assembly depending downwardly from said frame and pivotally coupled to said frame, said hanging chair assembly defining a person occupying space positioned entirely below said frame.

9. The tree stand of claim 8 wherein said top portion frame includes a pivot and wherein said hanging chair assembly is coupled to said pivot.

10. The tree stand of claim 8 wherein said having chair assembly includes a frame, a chair portion, and a plurality of hanging straps extending between a chair portion and said frame.

11. The tree stand of claim 10 wherein said hanging straps are adjustable in length.

12. The tree stand of claim 8 wherein said hanging chair assembly includes a coupler releasably coupled to said pivot.

13. The tree stand of claim 8 wherein said top portion includes a cantilever frame, a tree engaging portion, and a flexible cable releasably coupled to said cantilever frame.

14. The tree stand of claim 8 further comprising a canopy coupled to said top portion to form a roof.

15. The tree stand of claim 8 further comprising an enclosure surrounding said hanging chair assembly.

16. A tree stand adapted for use with an upright structure, the tree stand comprising,
a top portion having a frame which may be coupled to the upright structure, and a hanging chair assembly coupled to said frame so as to be pivotal relative to said frame, said hanging chair assembly being positioned entirely below said frame.

17. The tree stand of claim 16 wherein said hanging chair assembly including a chair suspending frame and a chair coupled to said chair suspending frame.

18. The tree stand of claim 17 wherein said having chair assembly further includes a plurality of hanging straps extending between said chair and said chair suspending frame.

19. The tree stand of claim 18 wherein said hanging straps are adjustable in length.

20. The tree stand of claim 16 wherein said frame of said top portion includes a pivot.

21. The tree stand of claim 20 wherein said hanging chair assembly includes a coupler releasably coupled to said pivot.

22. The tree stand of claim 16 wherein said frame of said top portion includes a cantilever frame, a tree engaging portion, and a flexible cable releasably coupled to said cantilever frame.

23. The tree stand of claim 16 further comprising a bottom portion which may be coupled to the upright structure.

24. The tree stand of claim 16 further comprising a canopy coupled to said top portion to form a roof.

25. The tree stand of claim 16 further comprising an enclosure surrounding said hanging chair assembly.
